(19) United States
(12) Patent Application Publication
(10) Pub. No.: US 2009/0243133 A1
(43) Pub. Date: Oct. 1, 2009

(54) FILM CALIPER CONTROL

(75) Inventors: Chiu P. Wong, Vadnais Heights, MN (US); Justin W. Wilhelm, Saint Paul, MN (US); Donovan C. Karg, JR., Vadnais Heights, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/389,426

(22) Filed: Feb. 20, 2009

Related U.S. Application Data
(60) Provisional application No. 61/067,573, filed on Feb. 29, 2008.

(51) Int. Cl. B29C 47/92

(52) U.S. Cl. 264/40.6; 425/140

(57) ABSTRACT

A film handling apparatus including an orienter for deforming a polymeric film, a cross-web heat distribution system configured to provide a selectable distribution of heat to the film in the orienter, a measurement device configured to measure at least a portion of a cross-web caliper of the film, and an automated controller that controls the cross-web heat distribution system to adjust heat distribution in response to the measured cross-web caliper of the film. The film handling apparatus can provide for at least partial automatic control of the caliper of a film while the film is being manufactured.

### RELATED APPLICATIONS

This application claims the benefit of U.S. Ser. No. 61/067,573, filed on Feb. 29, 2008, the disclosure of which is incorporated by reference herein in its entirety.

### TECHNICAL FIELD

The present disclosure relates controlling caliper variations in polymer films, and more particularly, controlling caliper variations in extruded, oriented polymer films.

### BACKGROUND

Polymer films may be manufactured by the process of extrusion and subsequent stretching in one or more film orienter devices. Throughout the film making process, a number of elements can contribute to variations in film caliper (e.g. optical or thickness) uniformity. For example, uniformity fluctuations can be caused by variations in a number of cross-web conditions, including, for example, variations in extrusion die lip profile, cross-web die temperature, cross-web casting wheel temperature, drafts in ambient air, and non-uniform tenter temperatures and/or pressures. Film uniformity is important in high quality multilayer films, especially in multilayer optical films. For a growing number of applications it is desirable for these films to exhibit a high degree of physical and optical uniformity over a large area.

In one technique for controlling cross-web caliper in film manufacturing, the heat applied to the film is adjusted and distributed as the film is processed in a film orienter, e.g. a tenter or a length orienter. For example, the cross-web heat distribution in an orienter may be adjusted by changing the position of individual channel blockers. The channel blockers prevent heat supplied by a heat source from reaching the film in certain areas, and this change in heat distribution generally results in a change in the caliper of the finished film.

Adjustments to the heat distribution are typically controlled by a manually driven control device. The numerous variables associated with the film manufacturing process can require a manually driven caliper control device be adjusted numerous times as the film moves through the tenter or the length orienter. For instance, numerous adjustments may be required to account for process drift associated with the film manufacturing process. In general, one or more system experts must constantly monitor and analyze system data (e.g., optical caliper monitor data) during a manufacturing run to calculate each of the numerous system adjustments needed to maintain the production of a film with suitable cross-web caliper profile. The expert calculated system adjustments are generally applied manually by making changes to the position of channel blockers with a hand cranked controller during a film manufacturing run.

### SUMMARY

As a result, the caliper control technique is tedious and complicated. Moreover, the nature of the manual and expert-driven control operations has inherent problems. For example, there may be limited availability of the experts required to monitor manufacturing runs. Also, manual hand cranking of a control device can present safety issues because of the proximity of the control device to hazardous areas of the film manufacturing line. Additionally, experts may have a limited ability to keep up with process drifts due in part to the complexity of the analysis and calculations necessary to make proper adjustments. The limited ability to keep up with process drifts in the film process results in a lower yield of suitable film from the manufacturing process. Further, the effectiveness of the expert analysis and calculations are limited by human-error, which may also decrease the yield of suitable film.

In general, the present disclosure relates to the control of film caliper during the film manufacturing process. More specifically, the present disclosure relates to the control of film caliper using an automated controller to control the cross-web heat distribution to a film within a film orienter (e.g., a length orienter or tenter). As stated before, the relative distribution of heat within a film orienter can influence the finished caliper of a film while the film is being manufactured. Heat distribution to a film in an orienter may be provided by a cross-web heat distribution system. Thus, an automated controller may control, at least in part, the finished caliper of a film by controlling a cross-web heat distribution system to make adjustments to the relative heat distribution to a film within an orienter. Adjustments to the relative heat distribution are determined by the automated controller in response to a measurement of the caliper of a film that is currently being produced by a film line. For example, an automated controller may analyze a caliper measurement of the film using a rapid convergence algorithm to determine adjustments that result in relatively quick and beneficial changes to the film caliper.

A cross-web heat distribution system that includes one or more actuators may be used in conjunction with the automated controller. Such actuators allow for the mechanized positioning of heat blocking members within a cross-web heat distribution system. The position of these blocking members generally dictates, at least in part, the heat distribution to a film in an orienter. Consequently, an automated controller can utilize the respective actuators to selectively reposition blocker members to adjust the relative heat distribution to a film in an orienter to control film caliper. The position of a blocking member may be monitored by an automated controller through the use of an encoder associated with respective blocking members.

In some embodiments, a cross-web heat distribution system includes a cooling device. For example, a cooling device may provide for a thermal barrier between heat produced by a heat source within a cross-web heat distribution device and the one or more actuators used to position the heat blocking members. Accordingly, a suitable operating temperature for the actuators may be maintained despite the relatively large amount of heat generated by the heat source and the relatively close proximity of the actuators to the heat.

The present disclosure also relates to a user interface that may be used to operate an automated controller and allow for user-friendly control of the caliper of a film while it is being manufactured in a film line. For example, a user-interface may present graphical representations of the measured film caliper to illustrate the current cross-web caliper profile of the film being manufactured at a given time. Such a graphical representation may allow a human operator to visualize the caliper profile of a film in the cross-web direction and inspect the respective profile in terms of uniformity and the like. As another example, the user interface may also present graphical and/or numerical representations of the current positions of heat blocking members to an operator. Proposed changes to the position of respective heat blocking members determined by the automated controller may also be presented to an operator through the user interface. Thus, the user interface may be used to indicate the changes to the cross-web heat distribution system that have been determined by an automated controller with respect to the positions of the heat blocking member and, optionally, may be used for confirmation by the operator to carry out the proposed changes. Additionally, a user interface may allow a human operator to instruct the automated controller to perform one or more of the techniques associated with the caliper control process.

In one embodiment, the invention is directed to a film handling apparatus comprising an orienter for deforming a polymeric film, the orienter having a heat distribution zone; a cross-web heat distribution system configured to provide a selectable distribution of heat to the film in the orienter, wherein the cross-web heat distribution system comprises a heat source that produces heat; a plurality of heat blocking members proximate the heat distribution zone; and a plurality of actuators, wherein the plurality of heat blocking members are movably positioned by the plurality of actuators such that at least one heat blocking member blocks at least a portion of the heat produced by the heat source from reaching the film; a measurement device configured to measure at least a portion of a cross-web caliper of the film, the measurement device positioned downstream from the cross-web heat distribution system; and an automated controller that controls the cross-web heat distribution system to adjust heat distribution in response to the measured cross-web caliper of the film.

In another embodiment, the invention is directed to a method comprising deforming a polymeric film in an orienter having a heat distribution zone and a cross-web heat distribution system associated with the orienter that is configured to provide a selectable distribution of heat to the film in the orienter, the cross-web heat distribution system comprising a heat source that produces an amount of heat; a plurality of heat blocking members proximate the heat distribution zone; and a plurality of actuators, wherein the plurality of heat blocking members are movably positioned by the plurality of actuators such that at least one heat blocking member blocks at least a portion of the amount of heat produced by the heat source from reaching the film; measuring at least a portion of a cross-web caliper of the film at a location downstream from the cross-web heat distribution system with a measurement device; and adjusting heat distribution in response to the measured cross-web caliper using an automated controller that controls the cross-web heat distribution system.

In another embodiment, the invention is directed to a computer-readable medium containing instructions to cause a processor to execute a method. The method comprises measuring at least portion of a cross-web caliper of a film at a location downstream of a cross-web heat distribution system; and adjusting heat distribution in response to the measured cross-web caliper using an automated controller that controls the cross-web heat distribution system. The film is manufactured on a film line that includes an orienter having a heat distribution zone, the cross-web heat distribution system associated with the orienter, and the automated controller. The cross-web heat distribution system comprises a heat source that produces an amount of heat; a plurality of heat blocking members proximate the heat distribution zone; and a plurality of actuators. The plurality of heat blocking members are movably positioned by the plurality of actuators such that at least one heat blocking member blocks at least a portion of the amount of heat produced by the heat source from reaching the film.

In another embodiment, the invention is directed to a system comprising a user interface module comprising a display screen and at least one input media coupled to the module. The user interface module presents information to an operator relating to one or more properties of at least one of a film line or film during the manufacturing of a film. The user interface module also allows the operator to interact with the film line.

Embodiments of the present invention may allow for one or more advantages. For example, controlling the caliper of a film using an automated controller may allow for increased yield of film with a suitable caliper profile by overcoming the inherent problems associated with manual and expert-driven control operations. In most cases, the need for experts may be reduced due to the automation of aspects of the film control that previously required expert supervision and analysis. Additionally, the need for experts may be reduced due to the user-friendly nature of the user interface. Furthermore, the yield of suitable film may be increased because the ability of an automated control device to analyze complex data for problems (e.g., process drifts) and make proper adjustments without the limitation of human-error is generally greater than that of a human operator. Moreover, cross-web caliper requirements may be met more rapidly and efficiently upon start-up which also increases the yield of suitable film during a manufacturing run.

As another example, embodiments may increase the overall safety of human operators during the manufacture of film on a film line by eliminating the safety hazards associated with manually operated control of heat blocking members. The positioning of heat blocking members by actuators instead of manual cranks significantly reduces the need for a human operator to be in close proximity to hazardous areas of a film manufacturing line while film is being produced.

As another example, embodiments of the present invention may be used to produce films with exceptional caliper uniformity in the cross-web direction. Films may also be produced with preprogrammed cross-web caliper profiles, or random or regular pattern-tailored two-dimensional and/or three-dimensional caliper profiles. Such highly-tailored profiles may be achieved using an automated controller and heat blocking members that are moveable using actuators. Embodiments can also be used to provide for automatic, fast and high resolution control of film caliper during the manufacturing of polymer film, and enable routine and good film manufacturing practices.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1A is a side-view schematic diagram of an exemplary film line.

FIG. 1B is a top-view schematic diagram of the exemplary film line of FIG. 1A.

FIG. 1C is a magnified side-view schematic diagram of a portion of the exemplary film line of FIG. 1A

FIG. 1D is a top-view schematic diagram of exemplary heat blocking members and actuators of a cross-web heat distribution system.

FIG. 2 is a functional block diagram illustrating an exemplary automated controller.

FIG. 3 is a schematic diagram of an exemplary cross-web heat distribution system.

FIG. 4 is a flow-chart illustrating an exemplary technique for controlling the caliper of a film using an exemplary automated controller.

FIGS. 5 through 10 are screen shots of graphical displays of a user interface during an exemplary multi-layer film manufacturing run.

FIG. 11 is a magnified view of a portion of FIG. 10.

### DETAILED DESCRIPTION

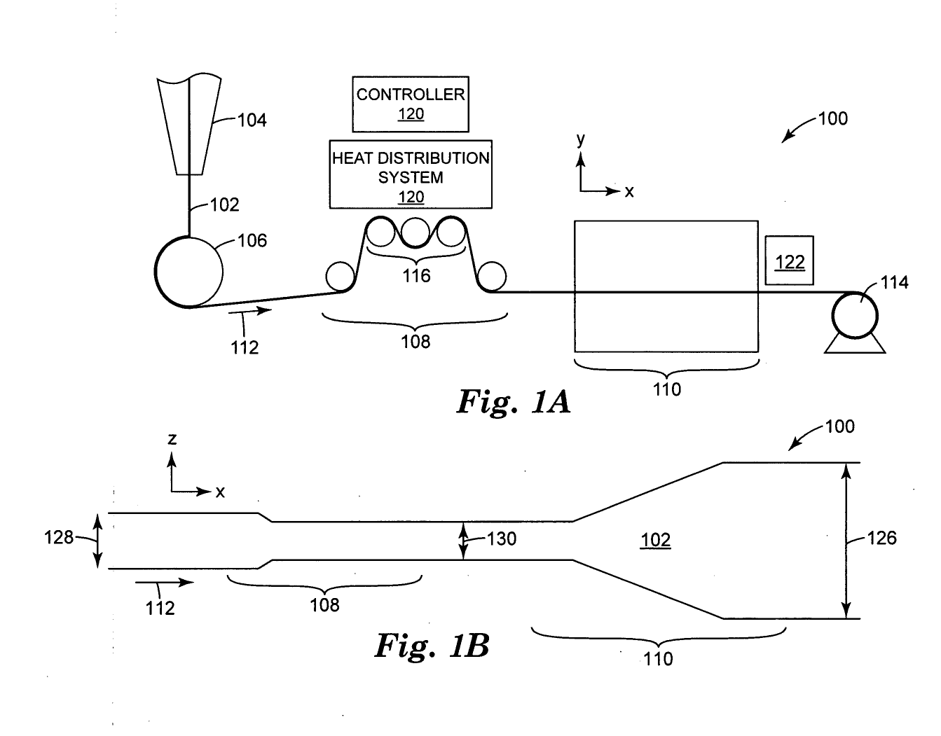

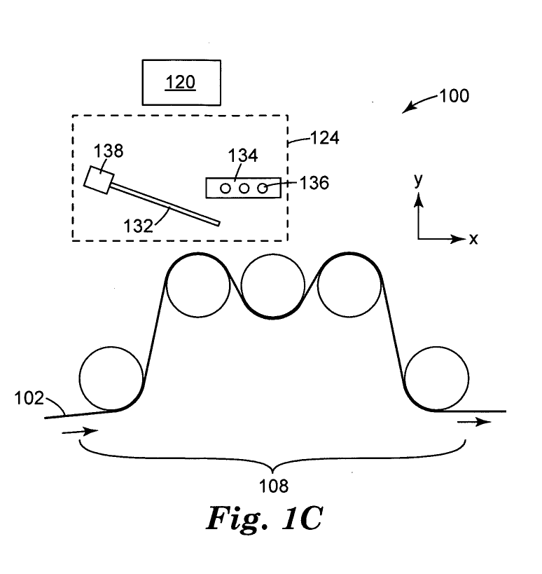

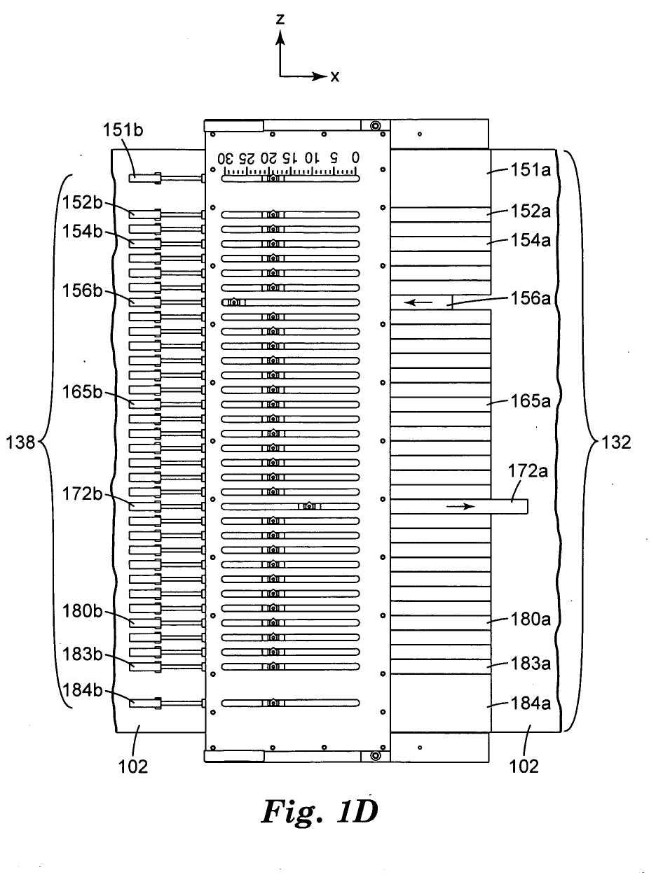

FIG. 1A is a schematic diagram of an exemplary film line 100. Film line 100 can be used to manufacture any extruded polymer film 102, and is particularly well suited to manufacture oriented, extruded polymer film 102 with multiple layers. Film line includes extrusion die 104, rotating casting wheel 106, length orienter 108, tenter 110, and film winder 114. Polymer film 102 moves through film line 100 in a relative machine direction represented by arrow 112. Polymeric melt is extruded through extrusion die 104 and is subsequently cooled on rotating casting wheel 106. After cooling on rotating casting wheel 106, film 102 enters length orienter 108 which stretches film 102 in the longitudinal direction (i.e., x-direction). After exiting length orienter 108, film 102 enters tenter 110 which is located downstream of length orienter 108. Tenter 110 stretches film 102 in the transverse direction (i.e., z-direction). After exiting tenter 110, film 102 is wound by film winder 114 and placed on a roll.

Generally, orienters may be used in a film line to orient a film after being extruded by an extruder during the manufacturing process. For example, an orienter may stretch a film at a desired ratio in one or more axial directions. The area of the orienter in which the film is stretched may be generally referred to as a stretch zone. Types of orienters include length orienters and tenters. For instance, as shown in FIG. 1A, length orienter 108 has a longitudinal stretch zone in which film 102 is stretched in the longitudinal direction relative the machine direction 112 by pull rolls 116. Additionally, tenter 110 has a transverse stretch zone in which film 102 is stretched in the transverse direction relative to the machine direction 112. A tenter is not limited to transverse stretch zones but may also include, for example, a machine direction stretch zone or a biaxial stretch zone.

FIG. 1B is a top-view schematic diagram of film line 100 of FIG. 1A which illustrates the relative cross-web width of film 102 in the z-direction corresponding to locations throughout film line 100 in the x-direction. As described before, film 102 is stretched in length orienter 108 in the longitudinal direction (i.e. x-direction) by pull rolls 116. Film 102 is subsequently stretched in the transverse direction (i.e. z-direction) by tenter 110. Due in part to the described stretching, the cross-web width 128 of film 102 upstream of length orienter 108 is greater than the cross-web width 130 downstream of length orienter 108 but less than cross-web width 126 of film 102 downstream of tenter 110. As configured, film 102 is sequentially and biaxially oriented in film line 100 by length orienter 108 and tenter 110. Although film line 102 includes two orienters 108 and 110, embodiments of the present invention may include any number of orienters to stretch a film during the manufacturing process.

Referring again to FIG. 1A, film line 100 further includes measurement device 122, cross-web heat distribution system 124, and automated controller 120. Heat distribution system 124 is associated with length orienter 108 and provides a selectable distribution of heat to the film in length orienter 108. Automated controller 120 controls cross-web heat distribution system 124 to adjust heat distribution within length orienter 108. Measurement device 122 measures the caliper of at least a portion of the caliper of film 102 in the cross-web direction (i.e., z-direction).

Measurement device 122 of film line 100 is located downstream of extruder 104, length orienter 108 and tenter 110, and upstream of winder 114. Such a device accurately measures all or a portion of the cross-web caliper of a film while the film is being manufactured on the film line 100. In general, the location of measurement device 122 allows for measurement that is representative of the cross-web caliper profile of film 102 in its finished state, including any changes to caliper of film 102 upstream in film line 100 (e.g., caliper changes as a result of the cross-web heat distribution to film within length orienter 108). Accordingly, a cross-web caliper measured by device 122 accurately represents the caliper profile of the finished film 102 and allows for precise analysis of the cross-web caliper profile of the film by automated controller 120. Furthermore, in this disclosure, caliper may refer to optical caliper, physical thickness caliper, a combination of the two, or any other thickness related property as required by the specific product design. Thus, a measurement device may measure physical thickness of the film, optical thickness of the film or, other thickness related properties of the film as described above. For example, measurement of the physical caliper of a film can be done using online traversing beta gauge scanning devices, such as those available from Honeywell International, Inc., Morristown, N.J., USA, under the trade designation Measurex. Other caliper gauges include without limitation beta transmission gauges, X-ray transmission gauges, gamma backscatter gauges, contact caliper sensors, and laser caliper sensors. Such gauges are commercially available, for example from NDC Infrared Engineering, Irwindale, Calif., USA. As another example, optical caliper may be measured using the devices and techniques described in PCT Published Application No. WO 2006/130142, which is incorporated herein by reference.

Cross-web heat distribution system 124 of film line 100 may be any suitable cross-web heat distribution system that provides a selectable distribution of heat to the film, and includes those described in PCT Published Application No. WO 2006/130142, which has been incorporated by reference herein. For example, cross-web heat distribution system 124 may include a heat source and a plurality of heat blocking members spanning all or some of film 102 in the cross-web direction, such that the plurality of heat blocking members are movably positioned to block at least a portion of the heat produced by the heat source from reaching film 102. Accordingly, the distribution of heat may be adjusted by repositioning one or more of the heat blocking members.

FIG. 1C is schematic diagram of a portion of the exemplary film line 100 of FIG. 1A. Specifically, the portion of film line 100 shown includes length orienter 108, cross-web heat distribution system 124, and automated controller 120. Cross-web heat distribution system 124 includes heat source 134. As illustrated, heat source 134 includes three heating elements 136 to produce heat, although a heat source may include any number and any type of heating elements suitable to produce heat within a cross-web heat distribution system. For example, heating elements 136 may be infrared heat lamps. Cross-web heat distribution system 124 further includes a plurality of heat blocking members 132 proximate to the heat distribution zone of length orienter 108 and a plurality of actuators 138 coupled to the plurality of heat blocking members 132. For the purposes of this application, the location of an orienter where the cross-web heat distribution system provides a selectable distribution of heat to film in the orienter will be referred to as a heat distribution zone. Accordingly, the location of the heat distribution zone is not limited to all or part of the stretch zone of an orienter but may also be located in additional orienter zones. Additional orienter zones include but are not limited to preheat zones, annealing zones and heat set zones (not shown in FIG. 1C).

As described above, cross-web heat distribution system 124 includes a plurality of actuators 138 coupled to the plurality of heat blocking members 132. As configured, for example, in FIG. 1C, the plurality of heat blocking members 132 are movably positioned by the plurality of actuators 138 to provide selectable distribution of heat to film 102 in length orienter 108 by blocking at least a portion of the heat produced by heat source 134 from reaching film 102. As described above, the distribution of heat reaching a film within an orienter can influence the caliper of the film being manufactured. For example, in some embodiments the plurality of heat blocking members may be positioned in a neutral location relative to the film in the orienter such that one or more of the heat blocking members is capable of being moved by an actuator both in a direction to increase the amount of heat reaching the film and, alternatively, in a direction to decrease the amount of heat reaching the film and, thus, influence the distribution of heat reaching the film. By motorizing the heat blocking members, the plurality of heat blocking members can be positioned and repositioned safely without manual input. Accordingly, any safety issues associated with hand cranking have been eliminated by incorporating actuators to position heat blocking members.

In general, any type of suitable actuator may be used that is capable of moving the heat blocking members within a cross-web heat distribution system. Types of suitable actuators may include but are not limited to electric actuators, pneumatic actuators, and hydraulic actuators. Suitable electric actuators may include but are not limited to electric motor actuators (e.g., alternating current electric motor actuators and direct current electric motor actuators). Suitable pneumatic actuators may include but are not limited to pneumatic motor actuators and pneumatic cylinder actuators. Suitable hydraulic actuators may include but are not limited to hydraulic motor actuators and hydraulic cylinder actuators. For example, in some embodiments, one or more electric motor actuators may be used to position the plurality of heat blocking members within a cross-web heat distribution system. In other embodiments, one or more hydraulic motor actuators may be used to position the plurality of heat blocking members within a cross-web heat distribution system. In still other embodiments, a combination of different types of actuators may be used to position the heat blocking members.

In addition, the number of individual actuators used to position the plurality of heat blocking members may vary. For example, in some embodiments, each individual heat blocking member is coupled to a separate individual actuator to allow for each blocking member to be moved individually and at the same time. In other embodiments, an individual actuator may be coupled to more than one individual heat blocking member such that the position of each of the individual heat blocking member cannot be moved individually but instead can only be moved together. In still other embodiments, an individual actuator may be coupled to more than one individual heat blocking member and may also include a switch to switch the actuator between individual heat blocking members to allow for separate movement of the respective individual heat blocking member but not at the same time.

FIG. 1D is a top-view schematic diagram of the plurality of heat blocking members 132 and the plurality of actuators 138 of cross-web heat distribution system 124. As illustrated by FIG. 1D, the plurality of heat blocking members includes thirty-four individual channel blockers 151a-184a adjacent to each other and spanning the entire width of film 102 to be controlled. The plurality of actuators 138 includes thirty-four individual actuators 151b-184b, corresponding to individual channel blockers 151a-184a. Each individual actuator 151b-184b movably positions corresponding individual channel blocker 151a-184a. For example, as illustrated by FIG. 1D, individual channel blockers 156a and 172a have been repositioned by actuators 156b and 172b, respectively. Particularly, individual blocker 156a has been moved from an initial position in the negative x-direction and individual blocker 172a has been moved from an initial position in the positive x-direction, as indicated by the coordinates displayed in FIG. 1D. The repositioning of individual channel blockers 156a and 172a by actuators 156b and 172b results in changes to the distribution of heat reaching film 102 in length orienter and changes the cross-web caliper of film 102.

In some embodiments, the physical dimensions of film 102 may extend beyond the width of film to be controlled, for example where the outside edges of film are cut away and discarded or recycled, leaving a useable central film portion. The width of each individual channel blocker 151-184 can be made as narrow as desired and the distance of the blockers to the film can also be tailored. For example, channel blockers can be 10 mm wide, and positioned within 50 mm of the film. In addition, the number of individual channel blockers that make up the plurality of heat blocking members can be tailored. Thus, the assembly of channel blockers as the controlling elements can be finely divided, and the cross-web caliper controlling scale can be tailored as desired, providing excellent cross-web caliper control.

Furthermore, although the plurality of heat blocking members 132 in FIG. 1D are illustrated as a plurality of channel blockers, heat blocking members are not necessarily limited to channel blockers. Other types of blocking members may be used to block at least a portion of the heat produced a heat source from reaching a film. In general, the configuration of heat blocking members is such that they provide in part for a selectable distribution of heat reaching a film in an orienter.

Referring again to FIG. 1C, film line 100 includes automated controller 120 which controls cross-web heat distribution system 124 to adjust the heat distribution to film 102 in length orienter 108. The heat distribution to film 102 in length orienter is adjusted in response to cross-web caliper of film 102 measured by measurement device 122 (shown in FIG. 1A). Although the plurality of actuators 138 motorizes the movement of the plurality of heat blocking members (e.g., as described above with respect to actuator 156b and channel blocker 156a), the exact position of the respective heat blocking members 132 is dictated by controller 120, generally by controlling the plurality of actuators 138. For example, automated controller 120 may analyze a measured cross-web caliper profile to determine what adjustments to should be made to the heat distribution to film 102 and then reposition the plurality of heat blocking members 132 using the plurality of actuators 138 to result in the desired adjustments. In some embodiments, the relative position of the plurality of heat blocking members may be monitored by an encoder. For example, a rotary encoder can be used to translate the angular position of the shaft an actuator coupled to a respective heat blocking member to a form that can be used by the automated controller to indicate the relative position of the respect heat blocking member corresponding to the actuator shaft position.

In general, the components used by automated controller 120 enable a rapid response time and a minimal number of control cycles to converge on a desired cross-web caliper profile (e.g., a substantially uniform cross-web caliper profile). For example, automated controller 120 may utilize fast caliper data retrieval software to minimize the time needed to retrieve the caliper measurements taken by measurement device 122 prior to the data being analyzed by automated controller 120 to determine what changes need to be made to cross-web heat distribution system to result in desirable caliper changes to film 102. Additionally, data may be analyzed by automated controller 120 using a rapid convergence algorithm to reduce the number of control cycles needed to converge to suitable cross-web caliper uniformity. In addition, control may be accomplished with at least one of error handling capability, edge abnormality handling, and gain calculation improvement.

In general, a suitable rapid convergence algorithm may analyze input data to determine changes to the cross-web heat distribution system that will make desirable heat distribution adjustments. For example, measured caliper input data may be used to derive values representing the difference between the current film caliper measured at a single location and the overall current cross-web mean caliper. Such differences are representative of the relative non-uniformity of the cross-web caliper of a film. Target caliper differential (i.e., changes to the caliper of the film at certain locations on the cross-web of the film) may then be derived based on the current deviations from the current mean caliper value. To improve the overall cross-web uniformity, a rapid convergence algorithm may modify the target differential values using a sensitivity model matrix, similar to those that are common to the cross-sheet control literature and industry, to arrive at what position changes for each of the respective heat blocking members should result in the caliper changes equal to the target differentials. Such a sensitivity model matrix can provide a linear mapping between a vector of actuator inputs and a vector of cross-web effects and may be derived analytically, empirically, or through a method that combines both analytical and empirical approaches. Such techniques are not limited to improving the uniformity of the cross-web caliper of a film, but may also be used to control the cross-web caliper of a film to non-uniform, tailored cross-web caliper profile (e.g., by determining target differential values based on the desired tailored profile instead of the current mean caliper value). Typically, the number of control cycles needed to conform to a desired profile depends on the accuracy of the sensitivity model. If a sensitivity model is one-hundred percent accurate, then a cross-web caliper profile can conform to a desired cross-web caliper profile in only one control cycle. If a sensitivity model is less than one-hundred percent accurate, it may take more than one control cycle for a cross-web caliper profile to sufficiently conform to a desired profile. For example, in some embodiments of the present invention, a rapid convergence algorithm may allow for a cross-web caliper profile of a film to sufficiently conform to a desired profile within two control cycles.

Furthermore, as illustrated by FIGS. 1A and 1B, cross-web caliper of the film may be measured downstream from the location in the film line where the cross-web heat distribution system influences the caliper of a film. Due in part to the processes utilized during the manufacture of a film, the width of the cross-web of the film at the measurement location may not be the same width as the width of the cross-web of the film at the location on the film line where the respective caliper changing techniques are being employed. For example, as described before, a film may be stretched in one or more axial directions by one or more orienters (e.g. a length orienter and/or a tenter) after being extruded but before the cross-web caliper is measured.

Accordingly, a mapping algorithm may be used by automated controller 120 to map one location to the other. A mapping algorithm essentially translates each cross-web position of the film at one location into a corresponding cross-web position on the film at another location. A mapping algorithm can take into account any or all of the factors that may affect how the film width differs between two locations, including without limitation stretching, contracting, bowing, whether the edges of the film at one location have been cut away, variations in cross-web uniformity before stretching, variations in cross-web temperature distribution in the tenter, or variations in the homogeneity of the extruded mixture. Thus, a measured film caliper profile may be mapped to the corresponding film line location where the respective caliper changes are made. In general, mapping of the caliper profile to the respective locations on a film line may aid in determining what adjustments to the heat distribution should be made to properly influence the caliper of a film at the correct cross-web position.

Mapping may be done in a number of ways including those mapping methods described in PCT Published Application No. WO 2006/130142, which has been incorporated by reference herein. For example, a simple mapping method includes dividing the width of film into a set of imaginary film lanes and estimating that the width ratio of the lanes on the film cross-web is approximately equal at all locations on the film line. This method assumes that each lane is stretched or deformed the same amount. Additional mapping methods can include physically marking the film with an indicator before stretching and measuring the location of the indicator after stretching. For example, a first method can include drawing two lines 50 mm from each edge of the film, then measuring the location of those lines after stretching and subdividing the width of film between the two lines into a number of lanes having equal width. Once again, this method assumes that each lane is stretched or deformed by the same amount. A third method may include drawing 50 indicator lines on the film, then stretching the film and measuring the location of each indicator line after stretching. A fourth method may include selectively adjusting a cross-web heat distribution system, e.g., selectively moving one or more of the heat blocking members, and measuring the effect on the stretched film, particularly the position of the effect on the cross-web of the film. This method is referred to as active mapping or mapping by bumping. A fifth method may use conservation of mass principles, wherein the cross-web caliper profile of the film is measured before and after stretching. Since mass is conserved during stretching, the volume of film also remains the same and the width of a given number of film lanes can be calculated from the two measured caliper profiles. Any of these mapping methods can be used to design an appropriate mapping algorithm to be utilized by an automated controller to aid in controlling the caliper of a film.

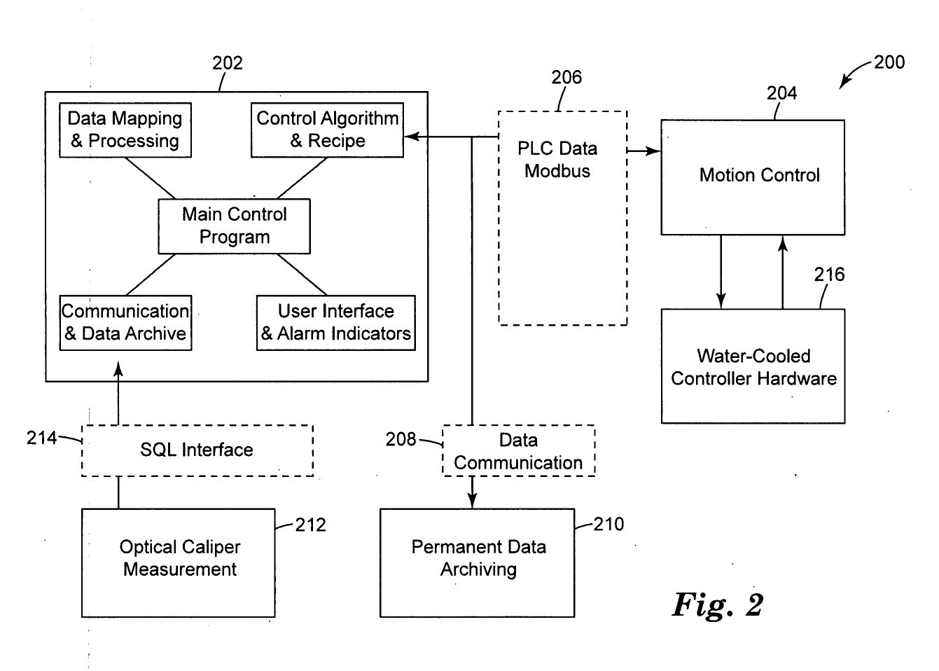

FIG. 2 is a functional block diagram illustrating exemplary automated controller 200. As illustrated by FIG. 2, automated controller 200 includes a main control program 202. Main control program 202 includes appropriate software and hardware to allow for data mapping and processing, communication and data archiving, a user interface and alarm indicators, and a control algorithm and recipe. As indicated by FIG. 2, main control program 202 retrieves data (e.g., optical caliper measurements) 212 using a structured query language (SQL) interface 214. Main control program 202 communicates with motion control 204 using a programmable logic controller (PLC) interface 206 (e.g., to control motion of heat blocking members). For example, data such as that regarding temperature relating to heat distribution within an orienter, relative positions and set points of heat blocking members, and the like may be communicated between main control program 202 and motion control 204 using PLC interface 206. Furthermore, main control program 202 provides for permanent or long term data archiving 210 using data communication 208 (e.g., Supervisory Control and Data Acquisition). As also illustrated by FIG. 2, motion control 204 is in communication with water-cooled controller hardware 216 (e.g., encoder, actuator). For example, water-cooled controller hardware 216 may communicate encoder information used to monitor the relative position of heat blocking members to motion control 204. As another example, motion control 204 may communicate voltage information to one or more actuators of controller hardware 216 to result in movement of one or more heat blocking members.

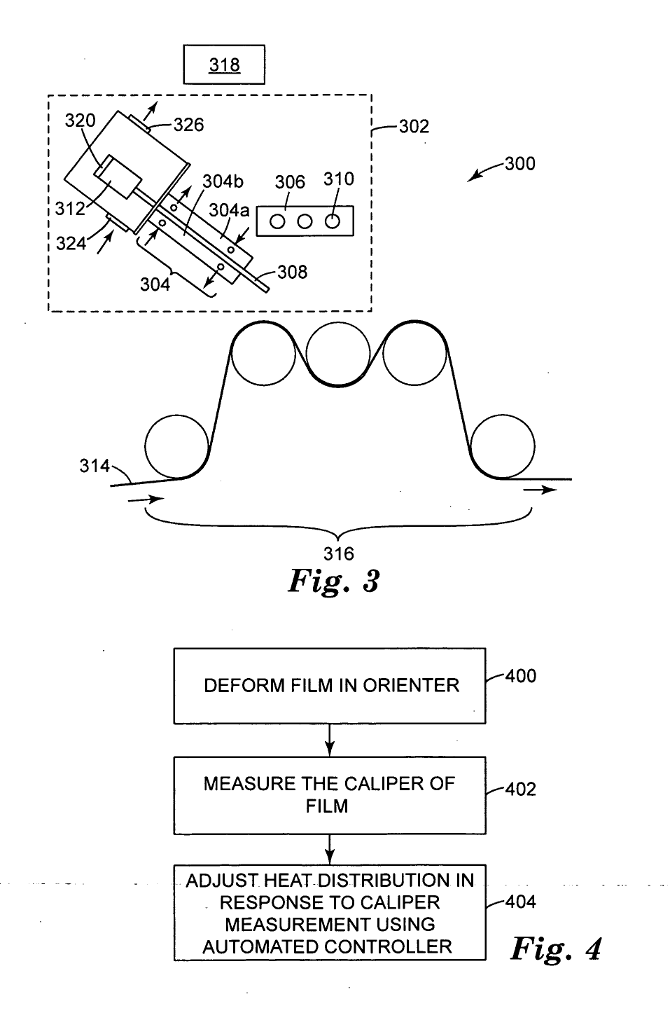

In some embodiments, a cross-web heat distribution system may further include a cooling device to provide a thermal barrier between a heat source and plurality of actuators in the system. FIG. 3 is a schematic diagram that illustrates a portion of an exemplary film line 300 including an embodiment of a cross-web heat distribution system 302 that includes first cooling device 304. Film line 300 is similar in operation and configuration to film line 100 described in FIGS. 1A-D, except for the differences between cross-web heat distribution system 302 and cross-web heat distribution system 124. As illustrated in FIG. 3, cross-web heat distribution system 302 includes heat source 306 with three heating elements 310, plurality of heat blocking members 308 proximate to the heat distribution zone, plurality of actuators 312 and plurality of encoders 320. The heat source 306 produces heat and plurality of heat blocking members 308 that are movably positioned by plurality of actuators 312 to enable cross-web heat distribution system 302 to make changes the caliper of film 314 by providing a selectable distribution of heat to film 314 in length orienter 316. Automated controller 318 controls cross-web heat distribution system 302 to adjust heat distribution in response to a cross-web caliper measurement of film 314 by a measurement device (not shown) downstream of length orienter 316. The position of each of the plurality of heat blocking members 308 is conveyed to controller 318 as described above by plurality of encoders 320 coupled to plurality of actuators 312.

As configured, the heat produced by heat source 306 may influence the components of the heat distribution system 302 as well as film 314 in length orienter 316. For example, a portion of the heat produced by heat source 306 may be absorbed by the plurality of heat blocking members 308 or portion thereof (e.g., the portions of the respective heat blocking members nearest heat source 306), and subsequently conducted through the plurality of heat blocking members 308 to the plurality of actuators 312 in addition to plurality of encoders 320 and/or other components (e.g., electrical components) associated with the cross-web heat distribution system 302. Such heat transfer of the heat produced by heat source 306 can result in thermal conditions that may negatively influence the operability of the plurality of actuators 312, plurality of encoders 320 and other components associated with heat distribution system 302. For example, an amount of heat produced by heat source 306 may be transferred to plurality of actuators 312 and the area proximate to actuators 312 through plurality of channel blockers 304 that results in a temperature increase of the actuators 312 to a temperature that is not suitable for one or more of the plurality of actuators 312 to be operated.

Accordingly, heat distribution system 302 includes cooling device 304 that is configured to provide a thermal barrier between the heat produced by heat source 306 and plurality of actuators 312 to allow only a portion or, in some embodiments, none of the heat produced by the heat source to reach the plurality of actuators. As shown in FIG. 3, cooling device 304 includes first liquid cooled block 304a and second liquid cooled block 304b positioned proximate to plurality of heat blocking members 308. Particularly, plurality of heat blocking members 308 are positioned between first block 304a and second block 304b, and only a segment of heat blocking members 308 protrude from first and second block 304a and 304b. Cooling water is cycled through pipes contained within respective cooling blocks 304a and 304b, represented by the arrows shown in FIG. 3. As configured, first cooling device 304 removes heat from plurality of heat blocking members 308 and reduces the amount heat that reaches plurality of actuators 312 and plurality of encoders 320 corresponding to the plurality of heat blocking members 308. In one aspect, the amount of heat absorbed by heat blocking members 308 is lessened because of the reduced area of heat blocking members 308 exposed to the heat (i.e., the segment protruding from first and second block 304a and 604b). As a result, the amount of heat that reaches plurality of actuators 312 allows for an operation of the respective actuators 312 at suitable temperature.

The amount of heat removed by a cooling device (e.g., first cooling device 304) that provides a thermal barrier within a cross-web heat distribution may vary. In some embodiments, a cooling device removes a sufficient amount of heat to allow for a suitable operating temperature of temperature sensitive components within a cross-web heat distribution device. For example, a cooling device may remove an amount of heat produced by a heat source within a cross-web heat distribution system to provide for an operating temperature of a plurality of actuators ranging from approximately 40 degrees Fahrenheit to approximately 140 degrees Fahrenheit, such as approximately 70 degree Fahrenheit to approximately 100 degree Fahrenheit.

Although first cooling device 304 is configured as two water cooled blocks 304a and 304b proximate to plurality of heat blocking members 308, embodiments of a cooling device are not limited to such orientations. Instead, a cross-web heat distribution system may contain other devices that provide for sufficient transfer of the heat produced by the heat source to allow for operation of other components associated with a heat distribution system. Types of other devices may include but are not limited to condensation cooling devices, Peltier junction cooling devices, and the like. Furthermore, a cross-web heat distribution device may also include more than one cooling device to allow for suitable operating conditions for the components associated with the heat distribution device. For example, as illustrated by FIG. 3, cross-web heat distribution device 302 also includes air cooled enclosure 322 that encloses plurality of actuators 312 and plurality of encoders 320. To reduce the temperature within enclosure 322, a gas (e.g., air) of relatively cool temperature is blown into inlet 324 of enclosure 322 and then exits through outlet 326, as represented by the arrows in FIG. 3. As configured, air cooled enclosure 322 provides a second cooling device for suitable operating conditions for plurality of actuators 312 and plurality of encoders 320 utilizing the movement and relatively cooler temperature of the gas to transfer an amount of heat out of the enclosure 322.

Another aspect of the present invention relates to techniques for controlling the cross-web caliper of a film, for example, by using an automated controller as described above to adjust the heat to film in an orienter. FIG. 4 is a flow-chart illustrating an exemplary technique for controlling the caliper of a film using an exemplary automated controller according to the present invention. As indicated by FIG. 4, a film may be deformed in an orienter during the film manufacturing process to impart certain properties and/or characteristics to a film (400). In general, deformation of a film in an orienter can include any stretching of the film or temperature change of the film that influences the properties and/or characteristics of the film. For example, as described above, an orienter can be associated with a cross-web heat distribution system that provides a selectable distribution of heat to the film within the orienter to influence the caliper of the film that is being manufactured.

As further indicated by FIG. 4, as measurement of the caliper of a film may be taken by a measurement device after the film has exited an orienter (402). The measurement may be analyzed by an automated controller to determine if the current caliper of the film being manufactured is suitable for the intended use of the film. If the caliper measurement indicates that the caliper of the film needs to be changed, the automated controller may adjust heat distribution in response to the caliper measurement (404). For example, the automated controller may reposition one or more heat blocking members within a cross-web heat distribution system using one or more actuators to adjust the heat distribution to change the caliper of the film being manufactured. To determine where the heat blocking members should be positioned, the automated controller can analyze the caliper measurement using, for example, a rapid convergence algorithm as described above.

A control technique, such as that illustrated by FIG. 4, may be performed multiple times during the manufacturing of a film on a film line to control the caliper of the film. Generally, after a film has responded to one heat distribution adjustment, the caliper may again be measured and analyzed to determine whether the adjustment has resulted in a film with a suitable caliper profile. Additional control cycles may be performed to further change the caliper of the film by adjusting the heat distribution until a film with a suitable caliper profile in being manufactured. Once a suitable profile has been achieved, control cycles may also be performed to maintain or further increase the suitability of the film being produced.

The techniques described in this disclosure may be implemented in hardware, software, firmware, or any combination thereof. If implemented in software, the software may be executed in a processor, which may refer to one or more processors, such as a microprocessor, application specific integrated circuit (ASIC), field programmable gate array (FPGA), or digital signal processor (DSP), or other equivalent integrated or discrete logic circuitry. Software comprising instructions to execute the techniques may be initially stored in a computer-readable medium and loaded and executed by a processor. Accordingly, this disclosure also contemplates computer-readable media comprising instructions to cause a processor to perform any of a variety of techniques as described herein. In some cases, the computer-readable medium may form part of a computer program product, which may be sold to manufacturers and/or used in a device. The computer program product may include the computer-readable medium, and in some cases, may also include packaging materials.

For example, in some embodiments, an automated controller may include appropriate hardware and software to control the caliper of a film manufactured using the systems and techniques as described herein. In some cases, an automated controller may include software that allows the controller to analyze measured cross-web caliper data using a rapid convergence algorithm to determine what changes should be made to the position of a plurality of heat blocking member in a cross-web heat distribution system to control the caliper of the film being manufactured by making adjustments to the heat distribution system Accordingly, the automated controller may control the caliper of the film to increase the uniformity of the cross-web caliper or may control the caliper of the film to produce a film with a tailored cross-web caliper profile.

In another aspect, the present invention relates to a user interface module associated with the automated caliper control systems and techniques described herein. For example, a user interface (e.g., the user interface shown as part of main control program 202 in FIG. 2) may present information to an operator regarding one or more properties associated with the film line and/or film during the manufacturing process (e.g., measured cross-web caliper profile of a film, heat distribution within an orienter, current position of heat blocking members, proposed new positions of heat blocking members). A user interface may also allow the operator to interact with the film line, or specifically the automated controller during the control process (e.g., to allow the operator to approve proposed repositioning of heat blocking members, to allow the operator to initiate and/or perform one or more steps associated with the caliper control process). Generally, a user interface may include a display screen and one or more input media that allow a control system to receive input from a human operator. The screen may be a display device (e.g., computer monitor) that is capable of displaying one or more graphical representations relating to the control system and process to an operator. Input media may include a touch screen, buttons, a scroll wheel, a mouse, trackball or other input media.

In some embodiments, an automated controller may include software to control a user interface to receive information from an operator and present graphical displays to present information to an operator. For example, a user interface may present a graphical display in the form of a graphical plot of measured caliper data to indicate to an operator the current and/or prior caliper profiles of a film being manufactured. Such displays may allow an operator to visualize the respective cross-web caliper profiles and also analyze changes in cross-web caliper profiles that have taken place over a period of time. A user interface may also present graphical indicators to indicate to an operator the current and/or proposed locations of heat blocking members within a cross-web heat distribution system. Furthermore, a user interface may present a range of options associated with the control system to the operator. For example, a user interface may present a graphical display in which an operator may input a command to manually reposition one or more heat blocking members to adjust heat distribution within a cross-web heat distribution system.

Furthermore, a user interface may allow for the operator friendly operation of an automated controller to control the caliper of a film. For example, a user interface may graphically present instructions to an operator detailing the steps required to operate the automated controller in a manner that will result in the manufacture of a film with a suitable cross-web caliper profile. In one embodiment, a user interface graphically presents one or more displays including a progression of step buttons that an operator “clicks” through using input media such as a mouse to complete all or a portion of the automated control process. For example, an operator may begin by pressing the first step button graphically presented by the user interface to execute the first task of the control process. This may include but is not limited to calibration and mapping of the system or retrieval of measured caliper data for analysis by the controller software. Additionally, step specific instructions can be graphically presented to instruct the user on what analysis or further actions are needed for the current step or to move on to the following step. In some embodiments, a user interface may present graphical displays in such a way to allow for a non-expert operator to intuitively progress through multiple steps that may be required, such as, for example, to initiate a control cycle or approve actions proposed by the automated controller. For example, after a current step has been completed, a user interface may highlight a button on a graphical presentation to indicate to an operator that it should be “clicked” to proceed to and execute the next step in the procedure. To ensure that an operator completes all required steps in order, a user interface may not allow for step buttons to be activated by an operator until all of the preceding steps have been successfully completed. Accordingly, a user may proceed through all necessary steps until the entire procedure is complete at which time the progression of step buttons is reset to begin with the first step again.

The disclosed embodiments may be used in the manufacture of films comprising one or more than one polymer. Films having more than one constituent polymer may have any morphological or structural form, including, but not limited to, miscible blends, immiscible blends in which one polymer is a continuous phase and one or more are dispersed phases, co-continuous blends, interpenetrating polymer networks, and layered films having any number of layers. The presently disclosed systems and methods are particularly useful for multilayer optical films. These systems and methods are also particularly useful for films comprising a polyester.

Multilayer optical films made by employing the disclosed system or methods may include, but are not limited to, mirror films, polarizing films such as reflective polarizers, display films, optical filters, compensating films, anti-reflection films, or window (energy control or solar control) films (for architectural, automotive, greenhouse, or other uses) that provide, for example, UV- or IR-screening, tinting, or shading.

Films made by employing the present systems or methods need not be multilayer optical films. Other high performance films can also benefit from the cross-web caliper control disclosed herein. High performance film applications include, but are not limited to, magnetic media base films for analog or digital recording of audio, video, or data, graphic arts films, reprographic films, overhead transparency films, photographic films, x-ray films, microfilms, photo print films, inkjet printing films, plain paper copier films, printing plate films, color proofing films, digital printing films, carbon ribbon films, flexographic printing films, gravure printing films, drafting and diazo printing films, holographic films, adhesive tape substrates, abrasives substrates, label films, release liner films, masking films, laminating films, packaging films, heat-seal films, lidding films, dual-ovenable films, barrier films, stamping foils, metallizing films, decorative films, archival and conservation films, electrical insulating films for wire and cable, motors, transformers, and generators, flexible printed circuit films, capacitor films, films for cards such as credit cards, prepaid cards, ID cards, and “smart cards”, window- or safety-films (security films) for scratch resistance, anti-graffiti, or shatter protection, membrane switch films, touch screen films, medical sensor and diagnostic device films, acoustic insulation films, acoustical speaker films, and drumhead films.

As described herein, aspects of the present invention relate to the automated control of the caliper of a film while it is being manufactured. In some embodiments, a caliper control process used to control the caliper of the film may be fully automated and, therefore, not require monitoring or input by a human operator. In other embodiments, a caliper control process used to control the caliper of the film may only be partially automated. For example, a human operator may still be required to monitor the overall control process, initiate control cycles, perform mapping and calibration steps, and/or approve actions proposed by the automated controller.

Furthermore, although the embodiments of the present invention have been described with respect to controlling the caliper of a film, the present invention is not limited only to the control of the caliper of a film. Instead, the embodiments of the present invention, including the techniques and systems described herein, may be utilized to control any processing-temperature dependent film property (i.e., any film property dependant at least in part on the temperature at a point during the processing of the film). For example, processing-temperature dependent film properties may include but are not limited to bagginess, shrinkage, refractive indexes, crystallinity, molecular orientation, local film stretch ratio and the like.

### Example

Objects and advantages of this invention are further illustrated by the following example, but the conditions and details, should not be construed to unduly limit this invention.

A multilayer optical film (MOF) was manufactured on a film line using a configuration similar to that illustrated and described with respect to FIG. 3. Particularly, the film line that included a length orienter that stretched the film in the longitudinal direction. The film line also included a cross-web heat distribution system that was associated with the length orienter. The cross-web heat distribution system included a heat source and thirty-four heat blocking members configured as channel blockers (which may also be referred to as “fingers”) similar to that shown in FIG. 1D. The heat source included infrared lamps to produce the heat necessary to influence the film in the orienter. Each channel blocker had a width of approximately 0.5 inches and a total stroke range of approximately 4 inches (i.e., the relative minimum and maximum position of each channel blocker differed by approximately 4 inches resulting in a range of motion of approximately 4 inches).

The cross-web heat distribution system further included thirty-four direct current electric motors and thirty-four encoders. This amount of electric motors allowed each channel blocker to be driven by a separate motor. Each individual encoder corresponded to a separate motor and was coupled to the respective channel blocker drive shaft to indicate axial rotation of each drive shaft, and thereby allowed the position of each respective channel blocker to be monitored.

Similar to that shown in FIG. 3, the cross-web heat distribution system also included two water-cooled aluminum blocks positioned proximate to each major surface formed by the thirty-four channel blockers. A segment of each of the channel blockers protruded past the water-cooled aluminum blocks to allow for one or more of the channel blockers to block a portion of the heat produced by the infrared lamps. Water was circulated through the respective cooling blocks at rate and temperature that allowed the cooling blocks to remove a portion of the heat absorbed by the protruded segments of the channel blockers. The cooling blocks provided for a temperature barrier between the heat produced by the infrared lamps, a portion of which was absorbed by the channel blockers, and the plurality of motors, encoders and other electrical components of the heat distribution system and associated automated controller.

In addition, the cross-web heat distribution system also included an air cooled enclosure similar to that shown in FIG. 3. The enclosure enclosed the motors, encoders and various other electrical components of the heat distribution system and associated automated controller. Ambient air at a temperature of approximately 70 degrees Fahrenheit was circulated through the enclosure during the operation of the cross-web heat distribution system to remove a portion of the heat to provide suitable operating conditions for the motors, encoder, and the like. In this case, the combination of the liquid cooled block and air cooled enclosure removed enough heat from the system to prevent the operating temperature in the enclosure from going above a temperature of approximately 95 degrees Fahrenheit or below a temperature of approximately 55 degree Fahrenheit.

The film line further included a measurement device downstream of the length orienter that measured the cross-web caliper profile of the film that was representative of the cross-web caliper of the finished film. More specifically, the measurement device was an optical caliper monitor capable of measuring the cross-web optical caliper profile while the film was being manufactured on the film line.

The film line further also included an automated controller similar to that described above. The automated controller included software and hardware that allowed for rapid retrieval of the optical caliper data measured by the optical caliper monitor and mapping of the data to the position of the length orienter. The automated controller further utilized a rapid convergence algorithm to analyze the data and determine if and what changes needed to be made to the position of the respective channel blockers within the cross-web heat distribution system to result in a more uniform cross-web caliper profile. The channel blockers were moved by the motors in accordance with the changes to the position of the channel blocker determined by the automated controller.

Furthermore, a user interface was associated with the film line described above. This user interface allowed for the human operator to interact with the film system, particularly the automated controller, and also presented information about the system to the operator. To further illustrate this example, multiple screenshots that were displayed as part of the user interface during the MOF film run will be used to describe the control of the film caliper during the MOF manufacturing run.

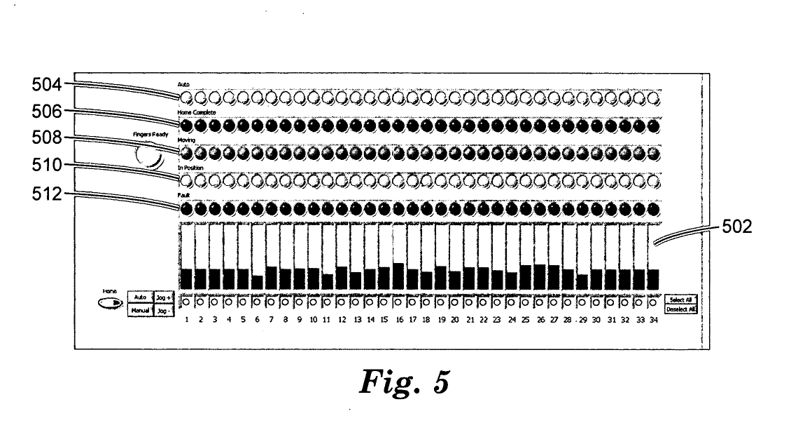

FIG. 5 is a screen shot of the graphical display of the user interface that was used for monitoring the status of the respective channels. As shown in FIG. 5, the display graphically represented what the current relative position of each of the thirty-four channel blockers was at the time the screen shot was taken. For example, as indicated by the bar chart 502 displayed in FIG. 5, channel blocker number 16 was positioned in a relatively extended position and channel blocker number 6 was positioned in a relatively contracted position.

In addition, the display shown in FIG. 5 also contains indicator rows 504, 506, 508, 510, 512 composed of thirty-four individual indicator circles that may be illuminated to indicate the state of each of the respective channel blockers. As illustrated by the five indicator rows displayed in FIG. 5, each channel blocker could be classified in any one of five states. Specifically, indicator row 504 indicates that the respective channel blocker is in “Auto” state (i.e., the channel blocker is subject to the automated controller and the position of the blocker will be moved according to the rapid convergence algorithm. Indicator row 506 indicates that the respective channel blocker is in “Home Complete” state (i.e., the zero position of the blocker has been successfully calculated by the automated controller). Indicator row 508 indicates that the respective channel blocker is in “Moving” state (i.e., the blocker is currently in the process of being moved by an actuator). Indicator row 510 indicates that the respective channel blocker is in the “In Position” state (i.e., the blocker is at the set position). Indicator row 512 indicatest that the respective channel blocker is in “Fault” state (i.e., motion control PLC has detected a fault on the respective channel, such as a problem with the actuator and/or encoder).

Furthermore, as illustrated by FIG. 5, the user interface allows a user to select or deselect one or more of the individual channel blockers to switch between automatic control mode or manual control mode. If a channel blocker is in manual control mode, a user may position the channel blocker manually using the user interface “jog” buttons (i.e., not under the control of the automated control system but still driven by the respective motors). If a channel blocker is in automatic control mode, then the position of the channel blocker is under the control of the automated control system.

To map and calibrate the cross-web heat distribution system and automated controller, a “bumping” technique was performed during the manufacturing run. In general, the position of two channel blockers was changed and the corresponding caliper changes to the cross-web caliper profile at the location of the measurement device were monitored. Specifically, the position of channel blocker number 8 was changed by approximately 0.5 inches in the positive direction (i.e., the direction that increases the amount of heat blocked by the channel blocker). In addition, the position of channel blocker number 25 was changed by approximately 0.5 inches in the negative direction (i.e., the direction that decreases the amount of heat blocked by the channel blocker). Once the channel blockers were repositioned, the cross-web caliper profile was monitored to determine the magnitude and location of the caliper change that resulted from the changes.

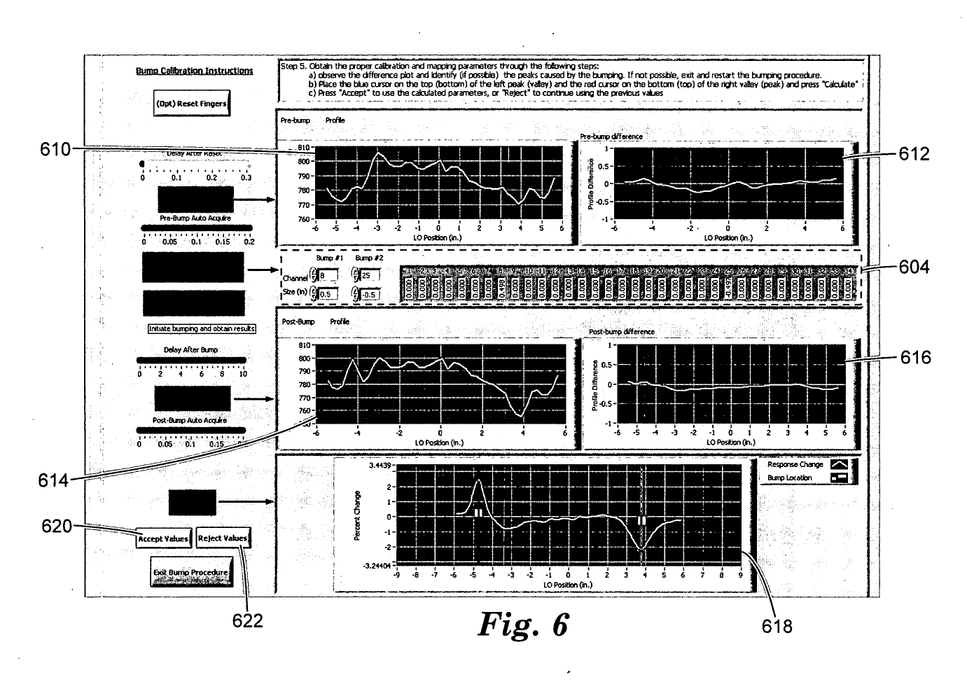

FIG. 6 is a screen shot of a graphical display of the user interface during the “bumping” process that was performed during the film manufacturing run as described above. As shown in FIG. 6, the display includes five individual graphs 610, 612, 614, 616 and 618, each of which represents various information about the bumping procedure. The horizontal axis of all of the graphs represents the cross-web location on the finished film in inches. For example, the approximate center location of the finished film is represented by the numeral zero. Accordingly, the negative two position on the horizontal axis represents the location on the cross-web that is approximately two inches from the center of the cross-web toward the left web edge and the positive two position on the horizontal axis represents the location on the cross-web that is approximately two inches from the center of the cross-web toward the right web edge.

Referring to FIG. 6, graph 610 is a plot of the measured optical caliper as a function of cross-web location at a time prior to the “bumping” of the two channel blockers. Graph 612 is a plot of the relative difference of two consecutive cross-web optical caliper measurements taken 5 minutes apart prior to the “bumping” of the respective channel blockers. Accordingly, graph 612 represented the relative stability of the system. For example, if the difference is within a prescribed error range (e.g., horizontal straight lines in graph 612), then the system is considered to be stable and the measured optical caliper may be used for subsequent calculations. Conversely, if the difference is not within, but rather outside a prescribed error range at one or more point, then the system is considered to be unstable. Accordingly, the measured optical caliper should not be used for subsequent calculations and operator should wait until the system is stable or should take actions to stabilize the system.

Area 604 in FIG. 6 allowed the operator to input which channel blockers were “bumped” and the extent of each respective “bump”. For example, as illustrated by the display in section, the operator selected channel blocker numbers 8 and 25 to be moved positive 0.5 inches and negative 0.5 inches, respectively. Additionally, area 604 displays information relating the movement of all thirty-four channel blockers during the “bump” process.

Graph 614 is a plot of the measured optical caliper as a function of cross-web location approximately 15 minutes after the “bump” was made by changing the position of channel blocker number 8 and channel blocker number 25, as described above. Also, similar to graph 612, graph 616 is a plot of the relative difference of two consecutive cross-web optical caliper measurements taken 5 minutes apart after the “bumping” of the respective channel blockers. As described before with respect to graph 612, graph 616 checks the stability of the system, in this case, after the “bumping” of the respective channels.

Graph 618 is a plot of the percentage change in measured optical caliper as a result of the “bump” as a function of cross-web location. The percent change is calculated from a comparison of the caliper data before the “bump” (e.g., the data displayed in graph 610) to the caliper data after the “bump” (e.g., the data displayed in graph 614). Additionally, graph 618 includes green indicators that indicate the position on the cross-web and the relative direction of movement of the channels that were “bumped” as described.

In addition to the information presented by the user interface as described with respect to FIG. 6, the user interface also allowed the operator to easily instruct the system to map and calibrate the system, including inputting the parameters to be used in the bumping process. For example, as described above, the operator selected which channel blockers were “bumped” and also the extent of the “bump”. Additionally, the operator was able to identify and select the peak and valley of the curve in graph 618, and then instruct the controller to calculate the proper calibration and mapping parameters based on the selected peak and valley. Moreover, the operator was allowed to view the calculated parameters and either accept the values for use by the automated controller by selecting button 620, or alternatively, reject the values by selecting button 622 and perform all or a portion of the process again to calculate new parameters for the automated controller to use.

After the mapping and calibration process was complete, the automated controller was used to improve the cross-web optical caliper uniformity of the film being manufactured in the film line. Specifically, the automated controller retrieved cross-web caliper measurement data from the measurement device using rapid retrieval software. That optical caliper data was subsequently mapped to the length orienter location on the film line and analyzed using a rapid convergence algorithm to determine what changes should be made to the positions of the channel blockers. The automated controller software then commanded the programmable logic controller to run the motors until all the channel blockers were at the positions determined by the automated controller using the rapid convergence algorithm.

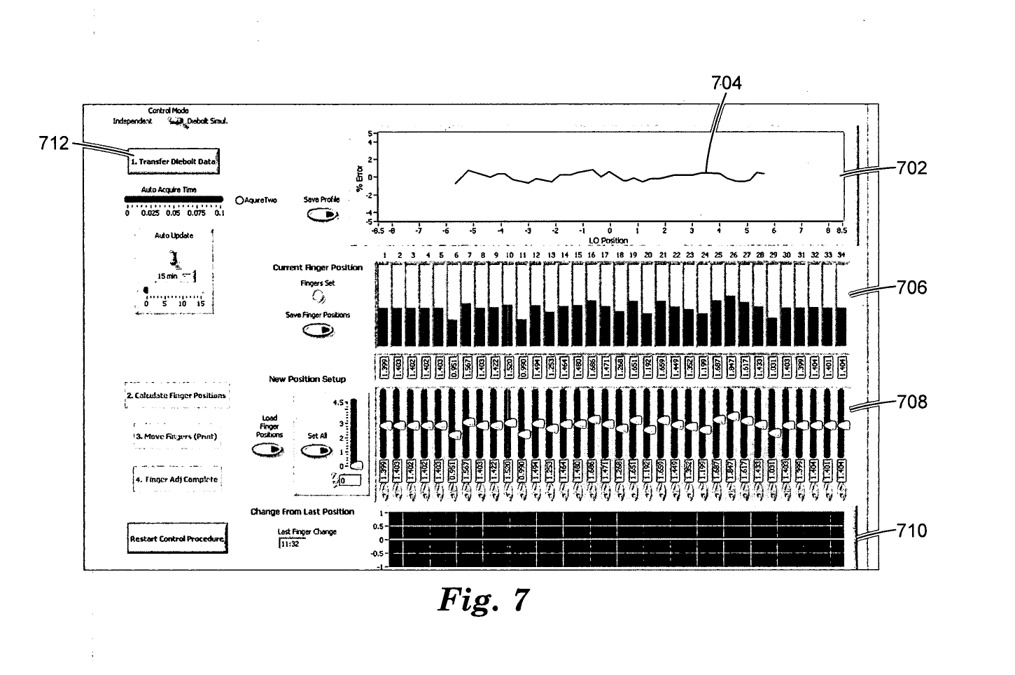

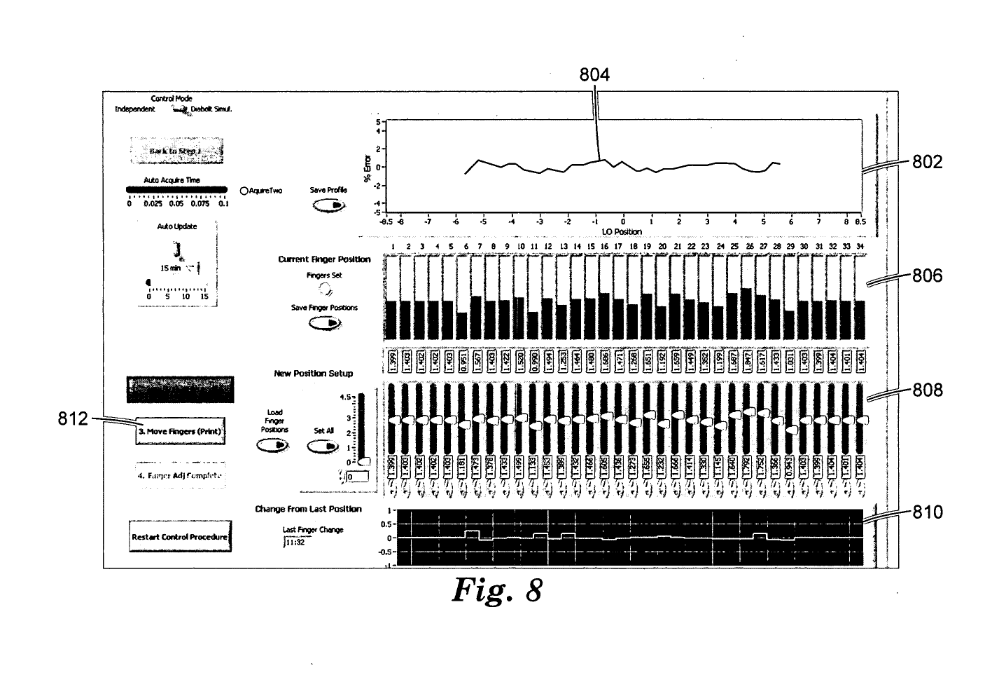

FIGS. 7-10 are screen shots taken during the control process that illustrate, inter alia, the control process and the user-friendly nature of the user interface in the operation of the automated controller to improve the uniformity of the film being manufactured.

FIG. 7 is a screen shot of a graphical display of the user interface illustrating the optical caliper data that was retrieved by the rapid retrieval software and mapped to the length orienter location on the film line. First graph 702 displays curve 704 which is a plot of the measured cross-web optical caliper as a function of relative length orienter position that was retrieved by the automated controller from the measurement device. As shown, the cross-web optical caliper is plotted in terms of percent error from the mean optical caliper measured overall versus position relative to the center of the web in the LO. Therefore, curve 704 illustrates the degree of cross-web optical caliper profile non-uniformity that the film exhibited at the respective point in time by displaying the deviations from the mean optical caliper. For example, curve 704 illustrates that, at the time of the retrieval, there was a deviation from the mean at a relative length orienter position of approximately negative 3.0 and approximately positive 4.8. As further indicated by the graphical display, curve 704 represents the cross-web caliper profile at a time of 18:40:02. Moreover, although only curve 704 is display by first graph 702 as shown, first graph 702 can also include more than one curve, wherein each individual curve represents the cross-web optical data that was measured at a different point in time. Therefore, first graph 702 can also illustrate the changes over time in the cross-web caliper profile of the film being manufactured by the film line.

The display shown in FIG. 7 further included second graph 706, third graph 708 and fourth graph 710. Second graph 706 indicated the current relative position of each of the thirty-four channel blocker at the time the screen shot was taken in the form of a bar chart. In addition, second graph 706 also displayed numerical values that more accurately indicated the position of each of the respective channel blockers. Third graph 708 indicated the proposed new positions of the channel blockers in the form of a bar chart and numerical values. Fourth graph 710 indicated the relative difference between the current and proposed positions of the channel blockers. In this case, the caliper data has only been retrieved by the automated controller and had not been analyzed by the rapid convergence software to determine channel blocker position changes. Therefore, the proposed new positions indicated by the display were the same as the current channel blocker positions indicated by the display.

As stated before, the retrieved optical caliper was analyzed using a rapid convergence algorithm to determine what changes should be made to the positions of the channel blockers. FIG. 8 is a screen shot of a graphical display of the user interface illustrating the position changes that were determined by the automated controller. The display shown in FIG. 8 includes first graph 802, second graph 806, third graph 808, and fourth graph 810, which indicate the same nature of information as described with respect to first 702, second 706, third 708, and fourth 710 graphs shown in FIG. 7, respectively. For instance, first graph 802 displays curve 804 that is a plot of cross-web optical caliper versus relative length orienter position measured at a relative time of 18:45:25. Second graph 806 indicates what the current relative position of each of the thirty-four channel blockers was at the time the screen shot was taken in the form of a bar chart. In addition, second graph 806 also displays numerical values that more accurately indicate the position of each of the respective channel blockers. Third graph 808 indicates the proposed new positions of the channel blockers in the form of a bar chart and numerical values. Fourth graph 810 indicates the relative difference between the current and proposed positions of the channel blockers.

At this point in time, unlike in FIG. 7, the caliper data had been analyzed by the automated controller. Accordingly, third graph 808 and fourth graph 810 indicated the changes to the positions of the channel blockers that were determined by the automated controller. For example, with respect to the position of channel blocker number 11, the automated controller determined that the channel blocker should be moved from a relative position of 0.990 inches to an approximate relative position of 1.133 inches (i.e., a position change of positive 0.143 inches). As another example, with respect to the position of channel blocker number 24, the automated controller determined that the channel blocker should be moved from a relative position of 1.199 inches to an approximate relative position of 1.145 inches (i.e., a position change of negative 0.054 inches).

As illustrated by FIG. 8, the operator was required to select button 812 on the display to approve that the controller to move the channel blockers to the proposed position changes. Button 812 was highlighted to indicate to the operator that the selection of button 812 was the next step in the process. After the operator selected the respective button 812, the proposed channel blocker position changes indicated in FIG. 8 were then implemented to adjust the heat distribution reaching the film in the length orienter. Specifically, the automated controller software commanded the programmable logic controller to run the motors until all the channel blockers were in the correct position.

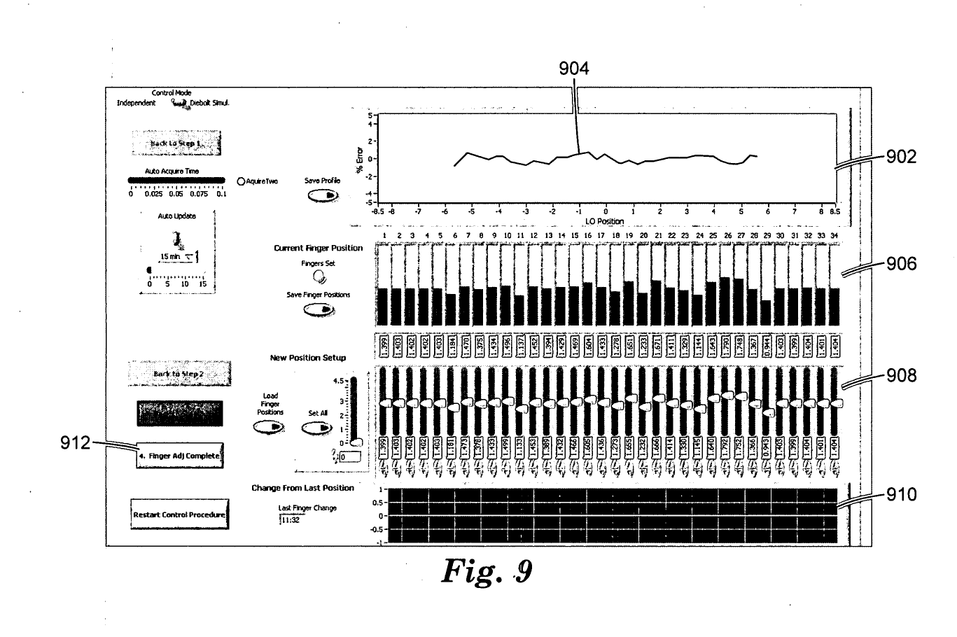

FIG. 9 is a screen shot of the graphical display of the user interface illustrating the position changes that were implemented after being determined by the automated controller using a rapid convergence algorithm. The display shown in FIG. 9 includes first graph 902, second graph 906, third graph 908, and fourth graph 910 which indicate the same nature of information as described with respect to first, second, third and fourth graphs of FIGS. 7 and 8. Curve 804 plotted in first graph 902 is identical to curve 804 in FIG. 8. Further, as indicated by second graph 906, the current position of the thirty-four channel blockers are within a specified tolerance value to the proposed positions indicated by third graph 808 in FIG. 8. For example, second graph 906 indicates that, at the time of the screenshot, channel blocker numbers 11 and 24 had a current position of 1.137 and 1.144, respectively. Additionally, as illustrated by FIG. 9, button 912 was highlighted to indicate to the operator that the channel blockers position changes were complete.

Because of the changes to the positions of the channel blockers, the distribution of heat that was reaching the film in the length orienter was adjusted. As a result, the cross-web optical caliper profile of the film was changed such that the relative uniformity of the cross-web caliper profile was increased after the film responded to the adjustment of the heat distribution within the orienter.

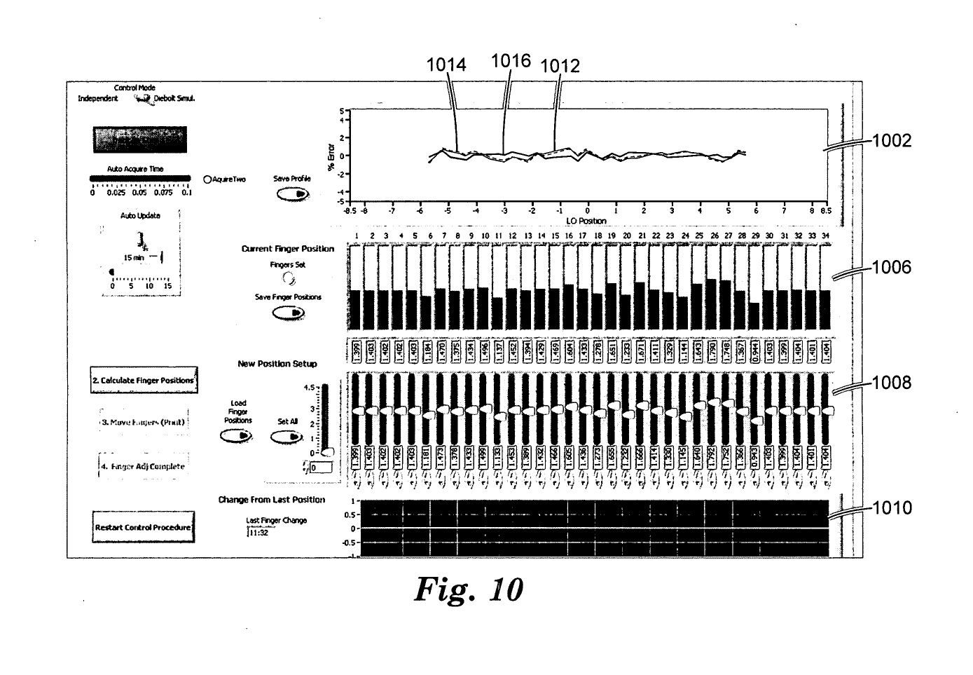

FIG. 10 is a screen shot of the graphical display of the user interface illustrating the cross-web caliper profile of the film approximately ten minutes after the channel blockers were moved by the motors to their new positions as determined by the automated controller. Again, the display shown in FIG. 10 includes first graph 1002, second graph 1006, third graph 1008, and fourth graph 1010 which indicated the same nature of information as described with respect to first, second, third and fourth graphs of FIGS. 7, 8, and 9.

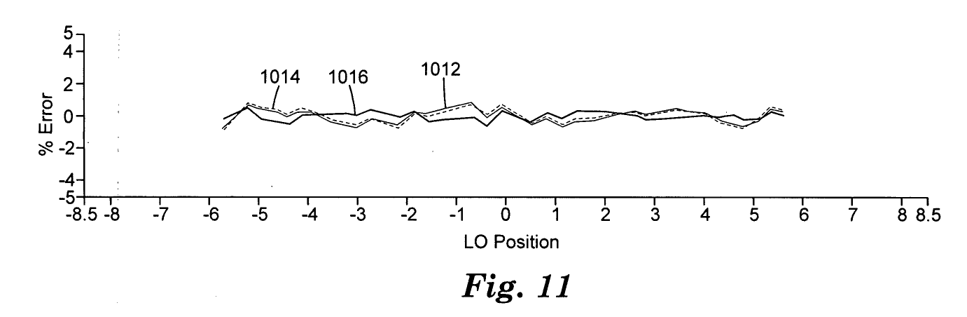

FIG. 11 is a magnified view of first graph 1002 that is shown FIG. 10. First graph 1002 includes first curve 1012, second curve 1014 and third curve 1016. Each curve is a plot of optical caliper of the film as a function of relative location on the length orienter measured at different times during the manufacturing of the film, and therefore indicates the cross-web optical caliper profile of the film at each respective time. Specifically, first curve 1012 is a plot of the optical caliper data that was measured at a relative time of 18:40:02, which is the same as curve 704 in FIG. 7. Second curve 1014 is a plot of the optical caliper data that was measured at a relative time of 18:45:25, which is the same as curve 804 in FIGS. 8 and 9. Thus, curve 1014 is a plot of the measured optical caliper data just prior to the channel blockers being moved as described above. Third curve 1016 is a plot of the optical caliper data that was measured at a relative time of 19:10:24, which is approximately ten minutes after the channel blockers were moved to their new positions as described above.

Accordingly, a comparison of the respective curves in graph 1002 shows that the optical caliper changes due to the adjustments in heat distribution made by the automated controller resulted in a more uniform cross-web optical caliper profile. For example, the deviation from the mean identified previously at relative length orienter position negative 3.0 and positive 4.8 has been decreased as a result of the changes to the cross-web caliper profile. Accordingly, the described example illustrates the feasibility of using the described film line, which included an automated controller, to control the cross-web optical caliper of a film while the film in being manufactured.

Various embodiments of the invention have been described. These and other embodiments are within the scope of the following claims.

1. A film handling apparatus comprising:
an orienter for deforming a polymeric film, the orienter having a heat distribution zone;
a cross-web heat distribution system configured to provide a selectable distribution of heat to the film in the orienter, wherein the cross-web heat distribution system comprises:
(a) a heat source that produces heat;
(b) a plurality of heat blocking members proximate the heat distribution zone; and
(c) a plurality of actuators, wherein the plurality of heat blocking members are movably positioned by the plurality of actuators such that at least one heat blocking member blocks at least a portion of the heat produced by the heat source from reaching the film;
a measurement device configured to measure at least a portion of a cross-web caliper of the film, the measurement device positioned downstream from the cross-web heat distribution system; and
an automated controller that controls the cross-web heat distribution system to adjust heat distribution in response to the measured cross-web caliper of the film.

2. The apparatus of claim 1, wherein the automated controller adjusts heat distribution at least in part by repositioning at least one of the plurality of heat blocking members.

3. The apparatus of claim 1, wherein the heat blocking members are channel blockers.

4. The apparatus of claim 1, wherein the cross-web heat distribution system further comprises a cooling device configured to provide a thermal barrier between the heat produced by the heat source and the plurality of actuators to allow only an amount of the heat produced by the heat source to reach the plurality of actuators.

5. The apparatus of claim 4, wherein the amount of the heat that reaches the plurality of actuators allows for an operating temperature of the plurality of motors ranging from approximately 40 degrees Fahrenheit to approximately 140 degrees Fahrenheit.

6. The apparatus of claim 5, wherein the amount of the heat that reaches the plurality of motors allows for an operating temperature of the plurality of actuators ranging from approximately 70 degrees Fahrenheit to approximately 100 degrees Fahrenheit.

7. The apparatus of claim 4, wherein the amount of the heat that reaches the plurality of actuators allows for an operating temperature of the plurality of actuators that is a suitable for operating the plurality of actuators.

8. The apparatus of claim 4, wherein the cooling device is a first liquid cooled block proximate to the plurality of heat blocking members

9. The apparatus of claim 8, further comprising a second liquid cooled block proximate to the plurality of heat blocking members, wherein the plurality of heat blocking member is positioned between the first liquid cooled block and the second liquid cooled block.

10. The apparatus of claim 1, wherein the actuators are at least one of an electric actuator, a hydraulic actuator, or pneumatic actuator.

11. The apparatus of claim 1, wherein the actuators are electric actuators, wherein the electric actuators are at least one of alternating current motor actuators or direct current motor actuators.

12. The apparatus of claim 1, wherein the plurality of actuators includes a number of individual actuators and the plurality of blocking members includes a number of individual blocking members, wherein the number of individual actuators relative the number of individual blocking members allows for each individual blocking member to be movably positioned by a separate individual actuator.

13. The apparatus of claim 1, wherein the cross-web heat distribution system further comprises a plurality of encoders corresponding to the plurality of actuators to monitor the position of the plurality of heat blocking members.

14. The apparatus of claim 1, wherein the orienter includes a first orienter and a second orienter, wherein the first orienter is a length orienter having a longitudinal stretch zone and the second orienter is a tenter.

15. The apparatus of claim 1, wherein the orienter is at least one of a length orienter or a tenter.

16. The apparatus of claim 1, wherein the automated control system analyzes the measured cross-web caliper using a rapid convergence algorithm to determine changes to the cross-web heat distribution system to make desirable heat distribution adjustments.

17. The apparatus of claim 16, wherein the rapid convergence algorithm utilizes a sensitivity model to determine the changes to the cross-web heat distribution system.

18. The apparatus of claim 1, wherein the measured cross-web caliper is mapped to the location of the cross-web heat distribution system.

19. A method comprising:
deforming a polymeric film in an orienter having a heat distribution zone and a cross-web heat distribution system associated with the orienter that is configured to provide a selectable amount of heat to the film in the orienter, the cross-web heat distribution system comprising:
(a) a heat source that produces heat;
(b) a plurality of heat blocking members proximate the heat distribution zone; and
(c) a plurality of actuators, wherein the plurality of heat blocking members are movably positioned by the plurality of actuators such that at least one heat blocking member blocks at least a portion of the heat produced by the heat source from reaching the film;
measuring at least a portion of a cross-web caliper of the film at a location downstream from the cross-web heat distribution system with a measurement device; and
adjusting heat distribution in response to the measured cross-web caliper using an automated controller that controls the cross-web heat distribution system.

20. The method of claim 19, wherein the automated control system adjusts heat distribution at least in part by repositioning at least one of the plurality of heat blocking members.

21. The method of claim 19, wherein the heat blocking members are channel blockers.

22. The method of claim 19, wherein the cross-web heat distribution system further comprises a cooling device configured to provide a thermal barrier between the heat produced by the heat source and plurality of actuators to allow only an amount of the heat produced by the heat source to reach the plurality of actuators.

23. The method of claim 22, wherein the amount of the heat that reaches the plurality of actuators allows for an operating temperature of the plurality of motors ranging from approximately 40 degrees Fahrenheit to approximately 140 degrees Fahrenheit.

24. The method of claim 23, wherein the amount of the heat that reaches the plurality of motors allows for an operating temperature of the plurality of actuators ranging from approximately 70 degrees Fahrenheit to approximately 100 degrees Fahrenheit.

25. The method of claim 22, wherein the amount of the heat that reaches the plurality of actuators allows for an operating temperature of the plurality of actuators that is a suitable for operating the plurality of actuators.

26. The method of claim 22, wherein the cooling device is a first liquid cooled block proximate to the plurality of heat blocking members

27. The apparatus of claim 22, further comprising a second liquid cooled block proximate to the plurality of heat blocking members, wherein the plurality of heat blocking member is positioned between the first liquid cooled block and the second liquid cooled block.

28. The method of claim 19, wherein the actuators are at least one of an electric actuator, a hydraulic actuator, or pneumatic actuator.

29. The method of claim 19, wherein the actuators are electric actuators, wherein the electric actuators are at least one of alternating current motor actuators or direct current motor actuators.

30. The method of claim 19, wherein the plurality of actuators includes a number of individual actuators and the plurality of blocking members includes a number of individual blocking members, wherein the number of individual actuators relative the number of individual blocking members allows for each individual blocking member to be movably positioned by a separate individual actuator.

31. The method of claim 19, wherein the cross-web heat distribution system further comprises a plurality of encoders corresponding to the plurality of actuators to monitor the position of the plurality of heat blocking members.

32. The method of claim 19, wherein the orienter includes a first orienter and a second orienter, wherein the first orienter is a length orienter having a longitudinal stretch zone and the second orienter is a tenter.

33. The method of claim 19, wherein the orienter is at least one of a length orienter or a tenter.

34. The method of claim 19, wherein the automated controller analyzes the measured cross-web caliper using a rapid convergence algorithm to determine changes to the cross-web heat distribution system to make desirable heat distribution adjustments.

35. The method of claim 34, wherein the rapid convergence algorithm utilizes a sensitivity model to determine the changes to the cross-web heat distribution system.

36. The method claim 19, further comprising mapping the measured cross-web caliper of the film to the location of the cross-web heat distribution system.

37. A computer readable medium comprising instructions to cause a processor to execute a method comprising:
measuring at least portion of a cross-web caliper of a film at a location downstream of a cross-web heat distribution system; and
adjusting heat distribution in response to the measured cross-web caliper using an automated controller that controls the cross-web heat distribution system,
wherein the film is being manufactured on a film line that includes an orienter having a heat distribution zone, the cross-web heat distribution system associated with the orienter, and the automated controller, wherein the cross-web heat distribution system comprises:
(a) a heat source that produces an amount of heat;
(b) a plurality of heat blocking members proximate the heat distribution zone; and
(c) a plurality of actuators, wherein the plurality of heat blocking members are movably positioned by the plurality of actuators such that at least one heat blocking member blocks at least a portion of the amount of heat produced by the heat source from reaching the film.

38. The computer readable medium of claim 37, wherein adjusting heat distribution comprises analyzing the measured cross-web caliper with a rapid convergence algorithm to determine changes to the cross-web heat distribution system to make desirable heat distribution adjustments.

39. The computer readable medium of claim 37, wherein the method further comprises mapping the measured cross-web caliper to the location of the cross-web heat distribution system.

40. A system comprising a user interface module operating on a computer, wherein the user interface module comprises a display screen and at least one input media coupled to the module, wherein the user interface module presents information to an operator relating to one or more properties of at least one of a film line or film during any of claims 19-36, wherein the user interface module allows the operator to interact with the film line.
